(19) United States
(12) Patent Application Publication
(10) Pub. No.: US 2013/0115834 A1
(43) Pub. Date: May 9, 2013

(54) PROTECTIVE BELLOWS FOR A MARINE STERN DRIVE UNIVERSAL JOINT

(71) Applicants: Carl Stone, Virginia Beach, VA (US); William Gremminger, Virginia Beach, VA (US); Emil Hasl, Virginia Beach, VA (US)

(72) Inventors: Carl Stone, Virginia Beach, VA (US); William Gremminger, Virginia Beach, VA (US); Emil Hasl, Virginia Beach, VA (US)

(73) Assignee: AB VOLVO PENTA, GOTHENBURG (SE)

(21) Appl. No.: 13/289,001

(22) Filed: Nov. 4, 2011

(51) Int. Cl. F16J 15/52

(52) U.S. Cl. 440/112

(57) ABSTRACT

A bellows for protecting a U-joint in a marine stern drive includes a flexible, hollow body defining an interior space and open at opposite ends, the body formed of a thermoplastic elastomer material to be self-supporting, having a first mating end and a second mating end and being pleated therebetween, a first sealing cuff formed of an elastomeric material, softer than the thermoplastic elastomer material, bonded to the first mating end and, a second sealing cuff formed of an elastomeric material, softer than the thermoplastic elastomer material, bonded to the second mating end.

### BACKGROUND AND SUMMARY

The present invention relates to inboard/outboard vessel drives and, more particularly, to universal joint bellows for inboard/outboard vessel drives.

In a stern drive or inboard/outboard drive, the engine is located inboard at or near the transom or stern of the vessel and is connected by a drive shaft which passes through the transom to provide power to the drive unit located outside the transom. Basic components of conventional inboard/outboard boats are shown in U.S. Pat. No. 7,559,814, U.S. Pat. No. 6,468,120, U.S. Pat. No. 6,468,119, and U.S. Pat. No. 6,585,545, all of which are incorporated by reference. To turn the boat to port or starboard, the stern drive unit is mounted to a gimbal ring, a fork, or another device that can be pivoted about a generally vertical axis. To raise the stern drive unit relative to the boat, which may be desirable for various reasons, such as when operating in shallow water, the stern drive unit is ordinarily pivotable relative to the gimbal ring, fork or about a horizontal axis.

A universal joint is typically provided in the drive shaft to allow the drive unit to be steered and tilted relative to the boat/engine. The universal joint is protected from exposure to water by a flexible rubber bellows. If the bellows is damaged or incorrectly assembled water will damage the bearings in the universal joint and also the support bearing which is mounted in the transom shield directly in front of the u-joint. An example of a stern drive with a bellows is shown in U.S. Pat. No. 4,938,726 to Bland, et al.

According to the conventional art, the universal joint bellows is made of a chloroprene rubber material with a steel wound wire interior support. The wire support maintains the rubber bellows in a shape defining an interior space to accommodate the universal joint. The rubber bellows also acts as a seal around the shaft opening in the transom shield and also around a shaft opening in the drive housing to keep water away from the drive shaft and the universal joint.

A problem with the conventional bellows is that movement experienced by the universal joint during normal operation of the drive can damage the bellows, during which, high loads and rubbing from the wound wire support can cause tears. In addition, rubber is quickly degraded by environmental effects such as ultraviolet radiation and ozone. As a result, current practice is to replace the bellows on a regular maintenance schedule, which adds time and cost which could be avoided.

The invention provides a bellows for a marine drive universal joint that overcomes the deficiencies in the art.

In non-marine applications, such as the automotive industry, bellows and boots for protecting are formed of thermoplastic elastomers, as described in U.S. Pat. No. 5,295,914 to Milavec. In addition, U.S. Pat. No. 5,236,204 to Hempel discloses a bellows formed of a thermoplastic elastomer and including rubber rings bonded to the outer surface of the end portions to accommodate clamping pressure and avoid cold flow problems with the thermoplastic elastomer. U.S. Pat. No. 4,560,178 to Hempel discloses a sleeve formed of a thermoplastic urethane and having folds in the mating ends to create voids that are filled with a permanent plastic sealing mass.

None of the above solves fully the problems with the conventional marine drive bellows, in the exposure to water and moisture.

According to the invention, a bellows body for a marine drive U-joint is formed of a thermoplastic elastomer, for example, a thermoplastic polyester elastomer such as Hytrel® available from E. I. DuPont de Nemours. A thermoplastic elastomer provides better fatigue and environmental resistance than rubber, improving and extending the service life of the bellows.

In addition, thermoplastic elastomer is a stiffer material, making the bellows body self-supporting and allowing the interior supporting wire to be eliminated.

According to another aspect of the invention, an elastomer, such as a natural or synthetic rubber, layer is overmolded onto end retaining portions of the bellows body to form sealing cuffs. The sealing cuffs provide engaging surfaces for contacting and sealing against engaging surfaces on the drive unit. Preferably, a rubber layer is molded to and thereby bonded to both an exterior and interior surface of the retaining portions of the bellows body to provide water-tight sealing surfaces. The sealing cuffs are coextensive with the retaining portions of the bellows and may extend beyond the ends of the retaining portions.

According to the invention, an apparatus for protecting a universal joint in a marine drive, the marine drive of the type including a transom shield, a propulsion unit pivotably connected to the transom shield, and a drive shaft including the universal joint extending from the transom shield to the propulsion unit, includes a flexible, hollow body defining an interior space and open at opposite ends, the body formed of a thermoplastic elastomer material and having a first retaining portion and a second retaining portion at the opposite ends thereof, and, a sealing cuff formed of an elastomeric material bonded to each of the first retaining portion and the second retaining portion.

According to one aspect of the invention, the sealing cuffs on at least one of the first retaining portion and second retaining portion include a circumferentially extending, radially inwardly projecting bead for engaging a groove on a respective mating surface of the marine propulsion unit.

According to one embodiment of the invention, a sealing cuff including a circumferentially extending, radially inwardly projecting bead is formed one each of the first retaining portion and the second retaining portion.

According to an alternative embodiment, a sealing cuff formed on the second retaining portion has a radially outwardly projecting flange and has an axially outwardly facing groove, the flange being engageable between cooperating surfaces of the propulsion unit and a pivot housing.

According to an aspect of the invention, the elastomeric material for the sealing cuff has a hardness less than the thermoplastic elastomer.

According to yet another aspect of the invention, the first retaining portion and the second retaining portion of the body are formed with axially extending slots. According to another aspect of the invention, the sealing cuffs formed on the first retaining portion and second retaining portion cover the slots.

According to one embodiment of the invention, the slots are T-shaped.

In another aspect of the invention, the body is corrugated between the first retaining portion and the second retaining portion, and may include at least one, and preferably a plurality of pleats between the first retaining portion and the second retaining portion.

According to an aspect of the invention, the body is self-supporting, requiring no internal supporting device.

### BRIEF DESCRIPTION OF THE DRAWINGS

The invention will be better understood by reference to the following Detailed Description read in conjunction with the appended drawings, in which:

FIG. 1 is a section view of an exemplary marine stern or inboard/outboard drive;

FIG. 2 is a section view of a marine stem drive showing a bellows according to an embodiment of the invention;

FIG. 3 is a perspective view of a bellows according to the invention;

FIG. 4 is a section view of the bellows shown in FIG. 3; and,

FIG. 5 is a section view of a marine stern drive showing a bellows according to an alternative embodiment of the invention;

### DETAILED DESCRIPTION

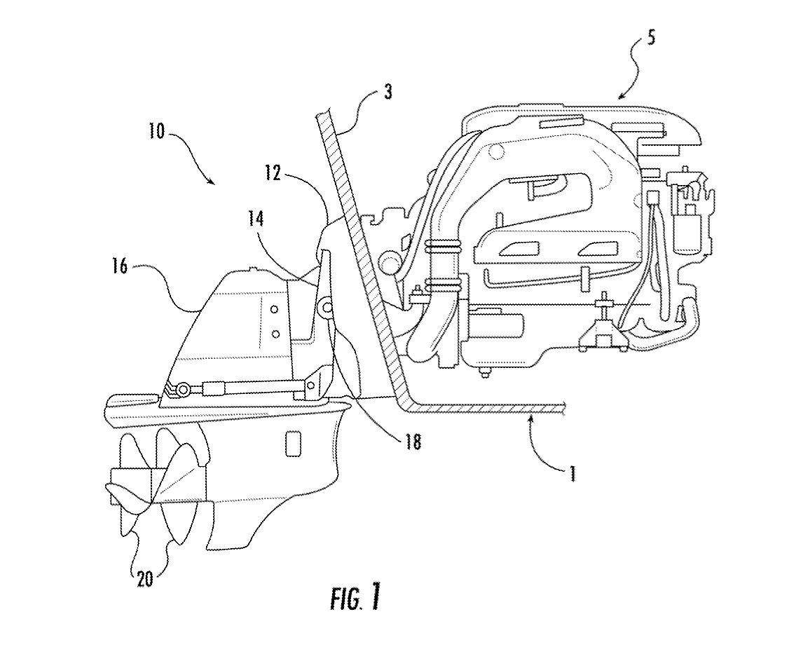

An exemplary stern drive assembly 10 for a marine vessel, for which the protective device according to the invention is useful, is shown in FIG. 1. The marine vessel includes a hull 1 having a transom 3 or stern. An engine 5 is installed in the hull 1 adjacent to the stern 3. A drive shaft (not shown) extends from the engine 5 through the transom 3 to connect with a propulsion unit 16.

As known in the art, a stern drive assembly 10 typically includes a transom shield assembly 12, a gimbal ring 14 and a drive housing 16. The transom shield assembly 12 is mounted to the stern 3 or transom of a vessel to support the drive assembly 10 and drive shaft (not illustrated) of the engine 5. The gimbal ring 14 is mounted to the shield assembly 12 for pivotal movement about a vertical axis to allow the drive housing 16 to pivot for steering the vessel. The drive housing 16 is mounted to the gimbal ring 14 for pivotal movement about a horizontal axis 18. The drive shaft (not illustrated in FIG. 1) extends from the engine 5 through the stern and into the drive housing 16. The drive shaft is connected to drive the propellers 20 through a vertical transmission shaft and a propeller shaft. To allow pivoting of the gimbal ring 14 relative to the shield assembly 12 and pivoting of the drive housing 16 relative to the gimbal ring, the drive shaft includes a universal joint.

A bellows (not shown in FIG. 1) covers the drive shaft in the space between the transom shield assembly 12 and the drive housing 16, where it would otherwise be exposed to water.

A stern drive as described above may include a pivot housing connecting to a bearing carrier, as described in U.S. Pat. No. 4,938,726 to Bland, et al., the contents of which are incorporated by reference herein. The drive shaft is supported in the drive housing by the bearing carrier.

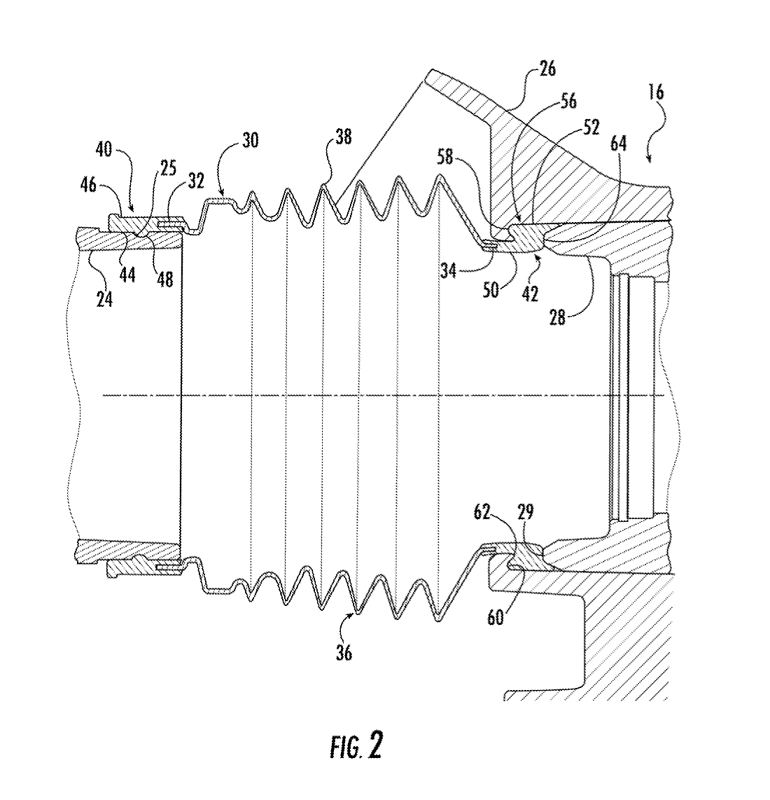

FIG. 2 shows a section view of a stern drive as in FIG. 1 and includes a bellows 30 according to one embodiment of the invention. As mentioned, a drive shaft (not illustrated) connecting the engine to the drive includes a universal joint to accommodate pivoting movement of the drive housing 16 relative to the shield assembly. The bellows 30 covers the drive shaft and universal joint to protect them from exposure to water and must also accommodate pivoting movement of the universal joint.

The bellows 30 is connected at a first end or first retaining portion 32 to a tube or stern 24 formed on the shield and extending therefrom. The first end 32 mates with the stem 24 by overlapping, fitting over, an end portion of the stem. The bellows 30 may be secured to the stem 24 by a band clamp (not illustrated) or other fastening device.

The bellows 30 is connected at an opposite second end or second retaining portion 34 to the pivot housing 26 and a portion of the drive housing assembly. In the illustrated embodiment, the second retaining portion 34 of the bellows 30 is secured between the pivot housing 26 and a bearing housing 28.

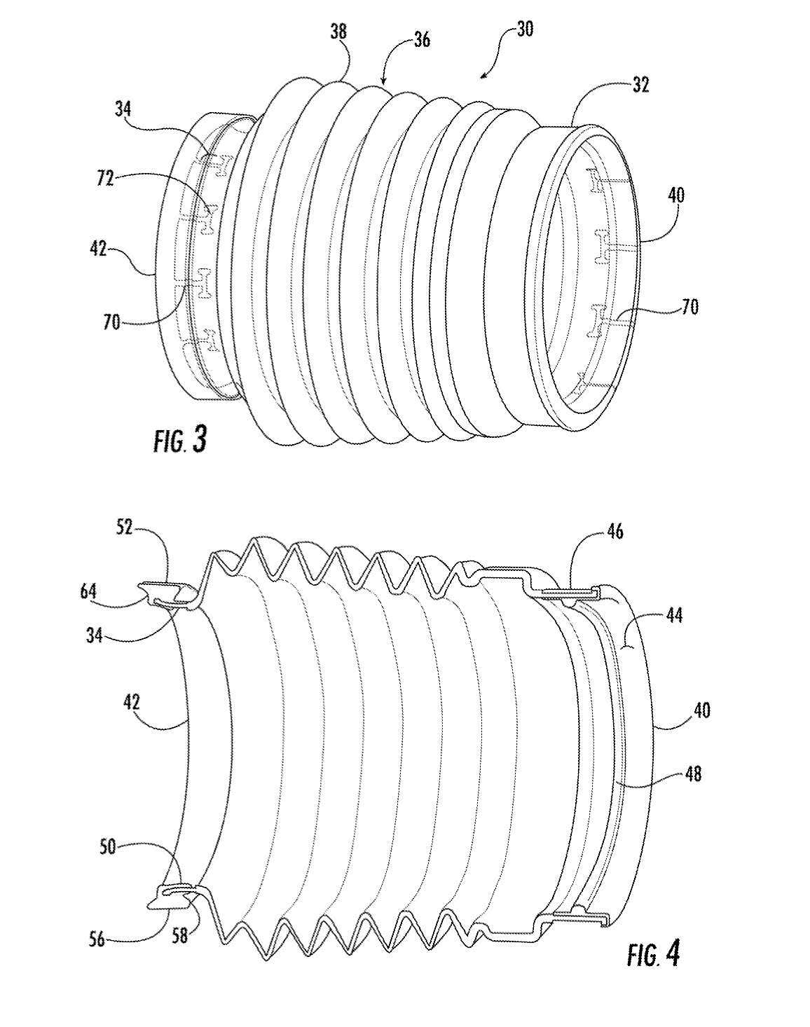

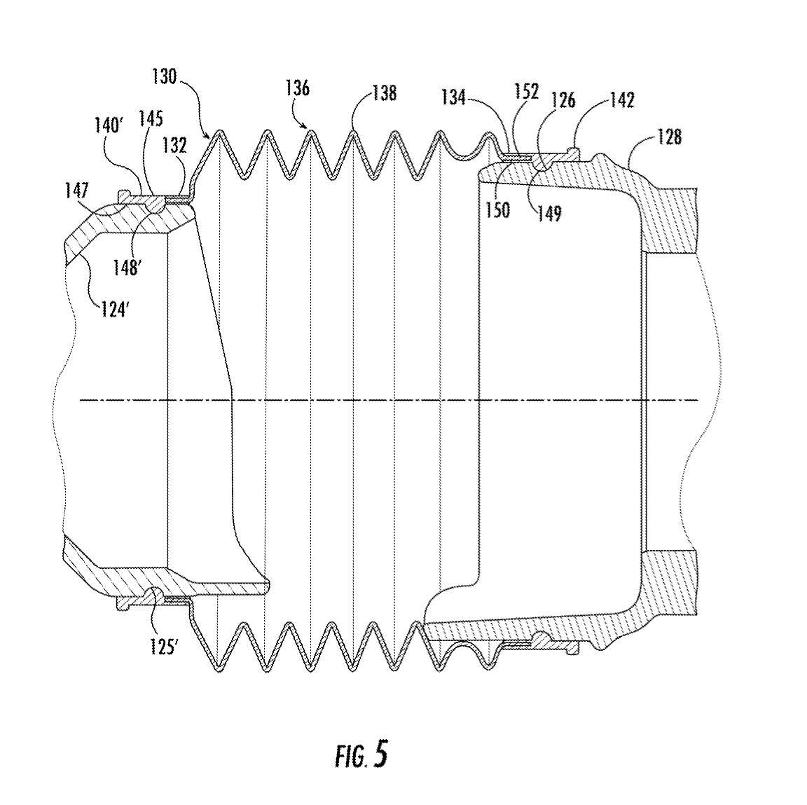

Turning to FIGS. 3, which shows a perspective view and FIG. 4, which shows a section view, the bellows 30 of the invention is formed as a hollow body 36 open at the first end 32 and second end 34. A portion 36 between the first retaining portion 32 and second retaining portion 34 is formed to allow bending, and may be pleated 38, with at least one pleat or fold, or, as illustrated and preferred, with a plurality of folds. The body 36 is formed of a thermoplastic elastomer, for example, a thermoplastic polyester elastomer such as Hytrel® available from E. I. DuPont de Nemours. A thermoplastic elastomer provides better resistance to fatigue and weathering than the currently used rubber, improving and extending the service life of the bellows. In addition, thermoplastic elastomer is a stiffer material than rubber, making the bellows self-supporting and allowing the interior supporting wire to be eliminated.

Thermoplastic elastomer, however, is too hard to provide a sufficient sealing surface with the transom and drive assembly to prevent water ingress. According to the invention, first and second sealing cuffs 40, 42, respectively, are bonded on the first 32 retaining portion and second 34 retaining portions of the bellows body 36. The sealing cuffs 40, 42 are formed of an elastomer, such as natural or synthetic rubber, having a hardness less than that of the thermoplastic elastomer, but also having good resistance to weathering and mechanical stress. For example, a thermoplastic rubber such an engineered thermoplastic vulcanizate 60A01HSL BK001 available from E. I. DuPont de Nemours & Co. has been found to be suitable

The elastomer provides an ability to stretch and compress so that cuffs 40, 42 can conform to the mating surfaces of the drive assembly. The cuffs 40, 42 in FIG. 3 are shown as transparent for the purposes of illustrating features of the first retaining portion 32 and second retaining portion 34 described in more detail below; however, transparency should not be understood as a necessary feature of the material. The first and second cuffs 40, 42 may be formed and bonded on the first retaining portion 32 and second retaining portion 34 by an over-molding process, or other convenient method.

With particular attention to FIGS. 2 and 4, the first cuff 40 is bonded or formed on the first retaining portion 32 to provide both an interior surface 44 and an exterior surface 46. A portion of the cuff 40 extends axially from the first retaining portion 32. Alternatively, the first cuff 40 may be coextensive with the first retaining portion 32, as shown in FIGS. 3 and 4. According to another alternative, the first cuff 40 is coextensive with the first retaining portion 32 and is formed thereon to provide an interior surface 44 only. The interior surface 44 includes a circumferential bead 48 that projects radially inwardly. As shown in FIG. 2, the bead 48 mates with a groove 25 formed in the stem 24 of the shield. The bead 48 and groove 25 cooperate to provide a water seal and help prevent relative movement of the first cuff 40 and stem 24.

Returning to FIGS. 2 and 4, the second cuff 42 is bonded or formed on the second retaining portion 34 to provide both an interior surface 50 and exterior surface 52. Alternatively, the second cuff 42 may be coextensive with the second retaining portion 34, as shown in FIG. 4. According to a further alternative, the second cuff 42 may be formed as an exterior surface 52 on the second retaining portion 34. As seen in FIG. 4, the second cuff 42 includes a flange 56 projecting radially outwardly from the exterior surface 52. The flange 56 is generally T-shaped in cross section to provide a ridge 58 projecting axially inward, that is, toward the first end 32. As seen in FIG. 2, the ridge 58 engages a pocket 60 in the pivot housing 24 defined by a lip 62. The flange 56 also includes a groove 64 defined by the T-shaped profile and an axially outward facing side of the flange. The groove 64 mates with a nose 29 formed in the bearing housing 28. The flange 56 is captured between the lip 62 in the pivot housing 24 and the nose 29 in the bearing housing 28, and may be compressed to form a water-tight seal. The outer surface 52 of the flange 56 is in contact with the pivot housing, further enhancing the seal.

As may be seen in FIG. 3, the first retaining portion 32 and second retaining portion 34 of the bellows both include slots 70 cut from the end axially inward. The slots provide a capacity to expand the first retaining portion 32 and second retaining 34 radially when positioning the first retaining portion 32 over the stem 24 and positioning the second retaining portion 34 inside the pivot housing 26 for good contact. Preferably, the slots are T-shaped as shown in FIG. 3, with circumferentially directed slots 72, shown here with a barbell shape, formed at the axially inward end of the axial slots 70. Alternatively, the slots 70 may be simple linear cuts in the first retaining portion 32 and second retaining portion 34.

A stern drive of another design may omit a pivot housing. This type of stern drive may have a steering fork, rather than a gimbal ring 14 as shown in FIG. 1. A steering fork is mounted to the transom shield for pivotable movement about a horizontal axis, and a marine propulsion unit is mounted to the fork for pivoting movement about a vertical axis. The invention applies as well to a stern drive of this configuration.

FIG. 5 shows a bellows 130 according to an alternative embodiment of the invention for stern drives lacking a pivot housing. The bellows 130 is mounted to and extends between a stem 124 on the shield assembly (not shown) and a bearing housing 128 of the propulsion unit (not shown). A first sealing cuff 140 is bonded to the first retaining portion 132. The first sealing cuff 140 is formed with layers on the interior side 145 and the exterior side 147 of the first retaining portion 132. A circumferentially extending, radially inwardly projecting bead 148 formed on the interior of the sealing cuff mates with a circumferentially directed groove 125 formed in a stem 124 formed on the transom shield.

The second retaining portion 134 includes a second sealing cuff 142 bonded thereto. The second retaining portion 134 engages the bearing housing 128 of the propulsion unit (not shown). The second sealing cuff 142 is formed with layers on the interior surface 150 and exterior surface 152 of the second retaining portion 134. A circumferentially extending, radially inwardly projecting bead 149 formed on the interior surface 150 engages a circumferential groove 126 formed in bearing housing 128.

Both the first retaining cuff 140 and second retaining cuff 142 extend beyond the end of the respective retaining portions 132, 134. The retaining portions 132, 134 with their respective sealing cuffs 140, 142 may be secured to the stem 124 and bearing housing 128 by band clamps (not illustrated).

The invention has been described in terms of preferred principles, embodiments, and components; however, those skilled in the art will understand that substitutions may be made for components without departing from the scope of the invention as defined in the appended claims.

What is claimed:

1. An apparatus for protecting a universal joint in a marine drive, the marine drive of the type including a propulsion unit pivotably mounted to a transom shield and a drive shaft including the universal joint extending from the transom shield to the propulsion unit, the apparatus comprising:
a flexible, hollow body defining an interior space and open at opposite ends, the body formed of a thermoplastic elastomer material and having a first retaining portion and a second retaining portion at the opposite ends thereof; and,
a first sealing cuff bonded to the first retaining portion and arranged to engage a mating surface associated with a transom shield and a second sealing cuff bonded to the second retaining portion and arranged to engage a mating surface associated with the propulsion unit, wherein, the sealing cuffs are formed of an elastomeric material having a hardness less than that of the thermoplastic elastomer.

2. The apparatus of claim 1, wherein the second sealing cuff is bonded to at least an exterior surface of the second retaining portion, and wherein the second sealing cuff is formed with a radially outwardly projecting flange having an axially outwardly facing groove, the flange being engageable between cooperating surfaces of the propulsion unit and transom shield.

3. The apparatus of claim 1, wherein, the first retaining portion and the second retaining portion are formed with axially extending slots.

4. The apparatus of claim 3, comprising a circumferentially directed cut at an end of each axially extending slot, wherein T-shaped slots are formed.

5. The apparatus of claim 1, wherein the first sealing cuff formed on the first retaining portion is bonded to at least an interior surface of the first retaining portion, the first sealing cuff having a circumferentially extending, radially inwardly projecting bead formed on an interior surface.

6. The apparatus of claim 5, wherein the first sealing cuff extends axially beyond an end of the first retaining portion.

7. The apparatus of claim 5, wherein, the first retaining portion and the second retaining portion of the body are formed with axially extending slots, and wherein, the sealing cuff and the mating member cover the slots.

8. The apparatus of claim 1, wherein, the second sealing cuff on the second retaining, portion is bonded to least an interior surface of the second retaining portion, the second sealing cuff having a circumferentially extending, radially inwardly projecting bead formed on an interior surface.

9. The apparatus of claim 8, wherein the second sealing cuff extends axially beyond an end of the second retaining portion.

10. The apparatus of claim 8, wherein, the first retaining portion and the second retaining portion of the body are formed with axially extending slots, and wherein, the first and second sealing cuffs cover the slots.

11. The apparatus of claim 10, comprising a circumferentially directed cut at an axially inward end of each axially extending slot, wherein T-shaped slots are formed.

12. The apparatus of claim 1, wherein, the body includes at least one pleat between the first retaining portion. and the second retaining portion.

13. The apparatus of claim 1, wherein the body includes a plurality of pleats between the first retaining portion and the second retaining portion.

14. The apparatus of claim 1, wherein the body is self-supporting.
